(19) United States
(12) Patent Application Publication
(10) Pub. No.: US 2025/0125706 A1
(43) Pub. Date: Apr. 17, 2025

(54) Power Conversion Circuit

(71) Applicant: CYNTEC CO., LTD., Hsinchu (TW)

(72) Inventor: Hsuan-Ju Chen, Hsinchu (TW)

(73) Assignee: CYNTEC CO., LTD., Hsinchu (TW)

(21) Appl. No.: 18/884,102

(22) Filed: Sep. 12, 2024

(30) Foreign Application Priority Data
Oct. 16, 2023 (TW) 112139330

(51) Int. Cl. H02M 1/00; H02M 7/217

(52) U.S. Cl. CPC H02M 1/0025; H02M 7/217

(57) ABSTRACT

A power conversion circuit is provided, which includes a control circuit. The control circuit includes a reference signal generation circuit, a comparator, an on-time control circuit and a driving circuit. The reference signal generation circuit is configured to compensate for a first reference voltage and generate an adjusted reference voltage. The reference signal generation circuit includes an operational amplifier circuit, a compensation capacitor and a compensation branch circuit. The operational amplifier circuit is configured to receive the first reference voltage and accordingly generate the adjusted reference voltage. The comparator is configured to output a comparison signal according to a signal related to the first output voltage and a signal related to the adjusted reference voltage. The on-time control circuit is configured to generate an on-time control signal according to the comparison signal. The driving circuit is configured to generate a driving control signal according to the on-time control signal.

### BACKGROUND OF THE INVENTION

### 1. Field of the Invention

The present disclosure relates to a power conversion circuit, and more particularly, to a power conversion circuit capable of improving system stability and output voltage accuracy.

### 2. Description of the Related Art

With advanced development in technology, various electronic products, such as notebooks, mobile phones, have been presented and are widely used in daily life. In general, a power conversion circuit is required for providing operating power for the electronic products. The power conversion circuit is capable of converting high voltage alternating current (AC) or direct current (DC) power to a low voltage and stable DC power for operations of the electronic products. Please refer to FIG. 1, which is a schematic diagram of a conventional power conversion circuit 1 with ripple-based constant on-time control scheme (RBCOT). The conventional power conversion circuit 1 with RBCOT provides fast transient response for switching operations. The power conversion circuit 1 includes a comparator 12, an on-time control circuit 14, a driving circuit 16, a main switch UG, an inductor L and an output capacitor C_{O}. The comparator 12 compares a voltage V_{FB} of a first output voltage V_{O} with a first reference voltage V_{REF}. When the voltage V_{FB} is lower than the first reference voltage V_{REF}, the comparator 12 generates a comparison signal TON_SHOT to trigger the on-time control circuit 14, such that the on-time control circuit 14 generates an on-time control signal S_{TON} with high-level pulse to the driving circuit 16. The driving circuit 16 controls the main switch UG to perform switching operations according to the on-time control signal S_{TON}, so as to convert an input voltage V_{I} into the first output voltage V_{O} and provide a load current I_{LOAD} to a load.

However, since the phase difference between the inductor current I_{L} and the first output voltage V_{O} of the power conversion circuit 1 is 90 degrees. If the equivalent series resistor ESR is too small (e.g., when multi-layer ceramic capacitors (MLCCs) may be adopted as the output capacitor C_{O}), the ripple voltage generated by the equivalent series resistor ESR may become too small. As a result, a sub-harmonic oscillation may occur, and thus the power conversion circuit 1 becomes unstable. According to the stability criterion of the power conversion circuit, the product of the output capacitor C_{O} and the equivalent series resistance ESR should be greater than half of an on-time duration T_{ON}. That is, when the product of the output capacitance C_{O} and the equivalent series resistance ESR is greater than half of the on-time duration T_{ON}, the power conversion circuit may operate in a stable state. The stability criterion of the power conversion circuit 1 with RBCOT may be expressed as follows:

$$ESR \times {C}_{0} > \frac{{T}_{ON}}{2} \qquad ( 1 )$$

Where ESR represents the equivalent series resistor of the output capacitor C_{O}, C_{O} represents the output capacitor, and T_{ON} represents on-time duration of the on-time control signal S_{TON}.

For example, please refer to FIG. 2, which is a waveform diagram of the operations of power conversion circuit 1 shown in FIG. 1. As shown in FIG. 2, when the equivalent series resistor ESR of the output capacitor C_{O} is too small to satisfy the stability criterion of equation (1), the phase difference between the peak value of the inductor current I_{L} of the inductor L and the peak value of the first output voltage V_{O} is 90 degrees and the sub-harmonic oscillation phenomena occurs during the on-time duration T_{ON}, thus causing the power conversion circuit 1 to become unstable.

In addition, under the RBCOT control scheme, the comparator 102 of the power conversion circuit 1 may compare the voltage V_{FB} Of the first output voltage V_{O} with the first reference voltage V_{REF}. As such, this negative feedback control mechanism controls the power conversion circuit 1 to perform switching operations based on whether the valley value of the voltage V_{FB} (or first output voltage V_{O}) is lower than the first reference voltage V_{REF}. For example, please refer to FIG. 3, which is a waveform diagram of the operations of power conversion circuit shown in FIG. 1 according to an alternative embodiment of the disclosure. As shown in FIG. 3, the starting point of the on-time duration T_{ON} is controlled and triggered after the voltage V_{FB} (first output voltage V_{O}) reaches the valley value. This means, the negative feedback control mechanism may be triggered only if the valley value of voltage V_{FB} (first output voltage V_{O}) is equal to the first reference voltage V_{REF}. When the ripple of the first output voltage V_{O} becomes larger, the difference between the first output voltage V_{O} and the first reference voltage V_{REF} becomes larger, thereby causing the problem of inaccurate output voltage. Thus, there is a need for improvement.

### SUMMARY OF THE INVENTION

It is therefore an objective of the present disclosure to provide a power conversion circuit capable of improving system stability and output voltage accuracy, to solve the abovementioned problem.

According to an embodiment of the present disclosure, a power conversion circuit is provided. The power conversion circuit includes a power supply, a main switch, an inductor, an output capacitor and a control circuit electrically connected in sequence. The control circuit includes a reference signal generation circuit, configured to compensate for a first reference voltage and accordingly generate an adjusted reference voltage, comprising: an operational amplifier circuit, comprising a non-inverting input terminal configured to receive the first reference voltage, an inverting input terminal, and an output terminal coupled to the inverting input terminal of the operational amplifier circuit and configured to generate the adjusted reference voltage; a compensation capacitor, coupled between the output terminal of the operational amplifier circuit and a ground terminal; and a compensation branch circuit, coupled between the output terminal of the operational amplifier circuit and the ground terminal and comprising an auxiliary switch and a current source connected in series; a comparator, comprising a first input terminal coupled to the output capacitor and configured to receive a signal associated with a first output voltage of the power conversion circuit, a second input terminal coupled to the reference signal generation circuit and configured to receive a signal associated with the adjusted reference voltage, and an output terminal configured to output a comparison signal; an on-time control circuit, coupled to the output terminal of the comparator and configured to generate an on-time control signal according to the comparison signal; and a driving circuit, coupled to the on-time control circuit and configured to generate a driving control signal according to the on-time control signal, so as to control operations of the main switch of the power conversion circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional power conversion circuit with ripple-based constant on-time control scheme.

FIG. 2 and FIG. 3 are waveform diagrams of the operations of power conversion circuit shown in FIG. 1.

FIG. 4 is a schematic diagram of a power conversion circuit according to an embodiment of the present disclosure.

FIG. 5 is a waveform diagram of the operations of power conversion circuit shown in FIG. 4 according to an embodiment of the disclosure.

FIG. 6-8 are schematic diagrams of the current source of the reference signal generation circuit according to alternative embodiments of the present disclosure.

FIG. 9 is a schematic diagram of the power conversion circuit according to an alternative embodiment of the present disclosure.

FIG. 10 is a schematic diagram of the power conversion circuit according to a second embodiment of the present disclosure.

FIG. 11 is a schematic diagram of the power conversion circuit according to a third embodiment of the present disclosure.

FIG. 12 is a schematic diagram of the power conversion circuit according to a fourth embodiment of the present disclosure.

FIG. 13 is a schematic diagram of the power conversion circuit according to a fifth embodiment of the present disclosure.

FIG. 14 is a schematic diagram of the power conversion circuit according to a sixth embodiment of the present disclosure.

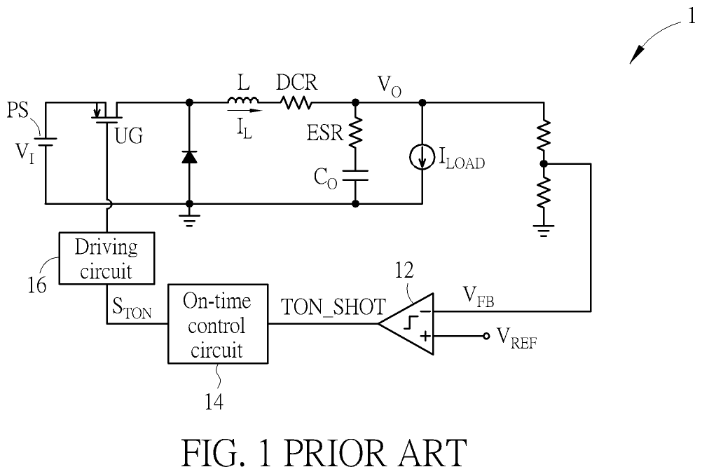

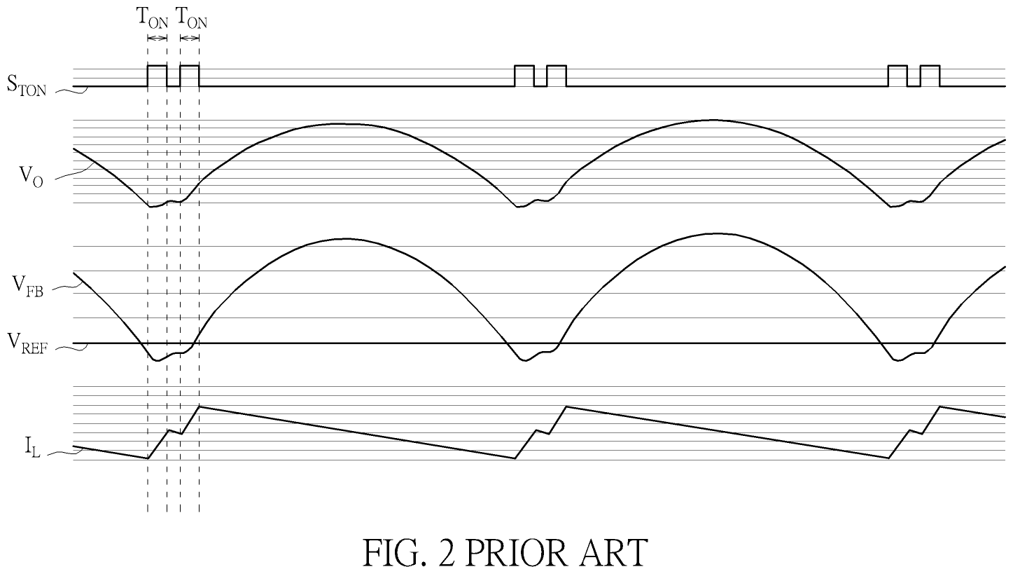

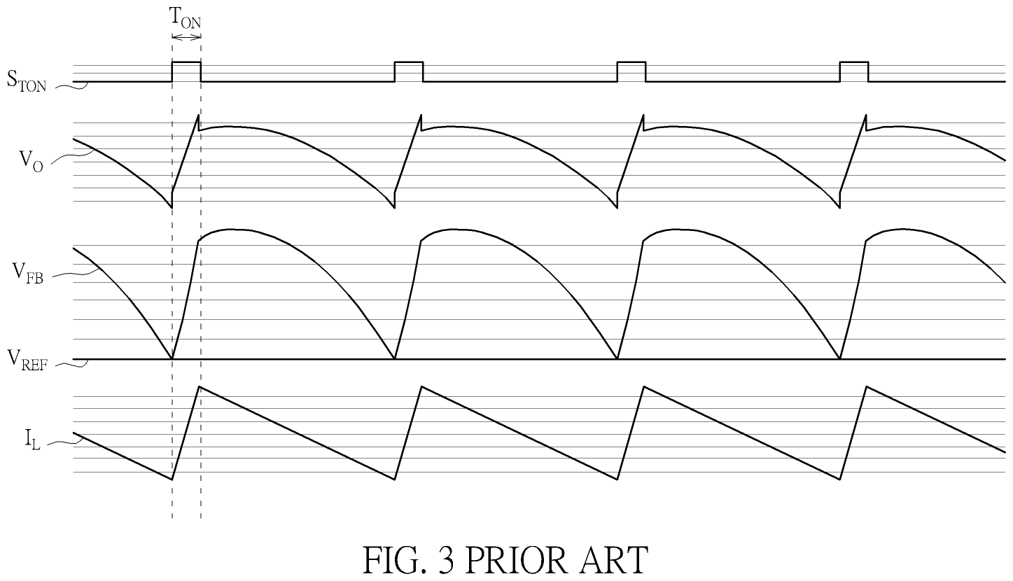

### DETAILED DESCRIPTION

In the description and throughout the claims that follow, the terms “include”, “comprise” and “have” are utilized in an open-ended fashion, and thus should be interpreted to mean “include, but not limited to”. The terms “couple” and “connect” are utilized to indicate that two or more elements are direct physical or electrical contact with each other, or two or more elements are indirect physical or electrical contact with each other.

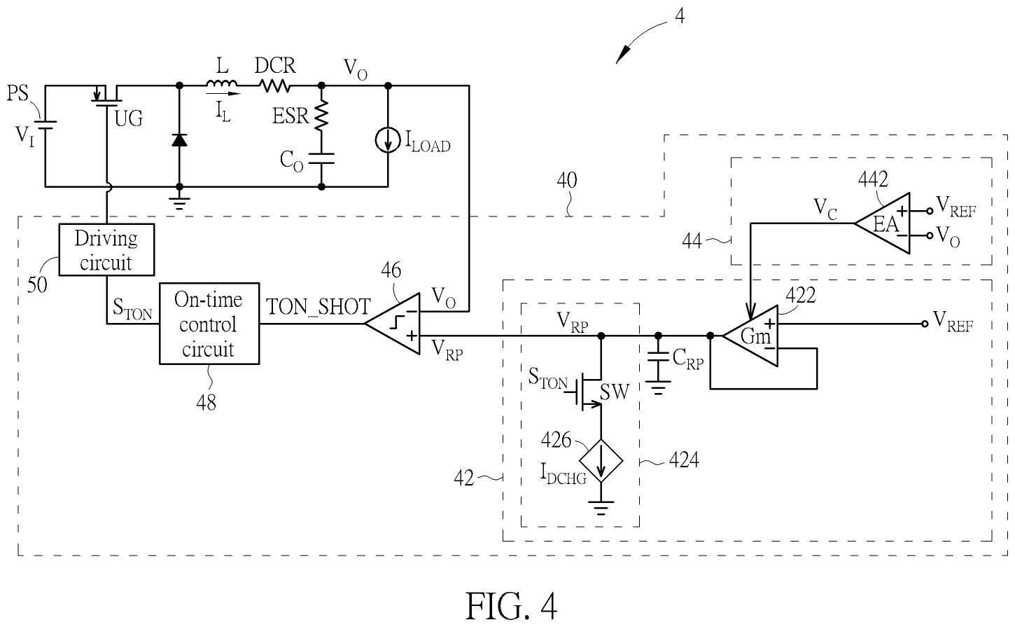

Please refer to FIG. 4, which is a schematic diagram of a power conversion circuit 4 according to an embodiment of the present disclosure. The power conversion circuit 4 is utilized for converting an input voltage V_{I} into a first output voltage V_{O} and accordingly providing a load current I_{LOAD} for a load. The power conversion circuit 4 includes, but is not limited to, a buck circuit. The load may be any electronic device that consumes electricity. The power conversion circuit 4 includes a power supply PS, a main switch UG, an inductor L, a direct current resistor DCR, an equivalent series resistor ESR, an output capacitor C_{O} and a control circuit 40 that are electrically connected in sequence. The control circuit 40 includes a reference signal generation circuit 42, an offset control circuit 44, a comparator 46, an on-time control circuit 48 and a driving circuit 50. The reference signal generation circuit 42 is configured to compensate for a first reference voltage V_{REF} and generate an adjusted reference voltage V_{RP}. The comparator 46 is configured to receive a signal associated with the adjusted reference voltage V_{RP} and a signal associated with the first output voltage V_{O} of the power conversion circuit 4, and accordingly generate a comparison signal TON_SHOT to trigger the on-time control circuit 48, such that the on-time control circuit 48 generates an on-time control signal S_{TON} with a high-level pulse (e.g., on-time duration is T_{ON}) to the driving circuit 50. The driving circuit 50 is configured to control operations of the main switch UG according to the on-time control signal S_{TON}. When the comparison signal TON_SHOT is at a rising edge, the control circuit 40 may control the main switch UG to be turned on and the inductor L may absorb electrical energy from the power supply PS and output the electrical energy to the load, such that the input voltage V_{I} may be converted into the first output voltage V_{O}.

The reference signal generation circuit 42 may compensate for the first reference voltage V_{REF} and accordingly generate the adjusted reference voltage V_{RP}. The reference signal generation circuit 42 includes an operational amplifier circuit 422, a compensation capacitor C_{RP}, and a compensation branch circuit 424. A non-inverting input terminal of the operational amplifier circuit 422 is configured to receive a first reference voltage V_{REF}. The first reference voltage V_{REF} may be generated by a voltage generator or a bandgap voltage reference circuit (not shown in figures). The first reference voltage V_{REF} may be a fixed value, and the first reference voltage V_{REF} may be set in accordance with practical requirements. An inverting input terminal of the operational amplifier circuit 422 is coupled to an output terminal of the operational amplifier circuit 422. The output terminal of the operational amplifier circuit 422 is configured to generate an adjusted reference voltage V_{RP}. The operational amplifier circuit 422 may be an operational transconductance amplifier, but not limited thereto. The compensation capacitor C_{RP} is coupled between the output terminal of the operational amplifier circuit 422 and a ground terminal. The operational amplifier circuit 422 and the compensation capacitor C_{RP} may form a unity gain buffer for buffering the first reference voltage V_{REF} received by the non-inverting input terminal of the operational amplifier circuit 422 and outputting the adjusted reference voltage V_{RP}.

Moreover, the compensation branch circuit 424 is coupled between the output terminal of the operational amplifier circuit 422 and a ground terminal. The compensation branch circuit 424 includes an auxiliary switch SW and a current source 426 connected in series. The auxiliary switch SW is controlled by the on-time control signal S_{TON} generated by the on-time control circuit 48. For example, during the on-time duration T_{ON} of the on-time control signal S_{TON}, the auxiliary switch SW is switched to the on state (i.e. the auxiliary switch SW is turned on) according to the on-time control signal S_{TON}. For example, the auxiliary switch SW may be a metal-oxide semiconductor field-effect transistor (MOSFET), a bipolar junction transistor (BJT) or other elements with similar functions, but not limited thereto. The current source 426 is configured to generate a first current I_{DCHG}. When the auxiliary switch SW is turned on, the first current I_{DCHG} discharges the compensation capacitor C_{RP} so as to adjust the level of the adjusted reference voltage V_{RP}. For example, the current source 426 may be a constant current source, but not limited thereto. In other words, the compensation branch circuit 424 is controlled by the on-time control signal S_{TON} to periodically discharge the compensation capacitor C_{RP}.

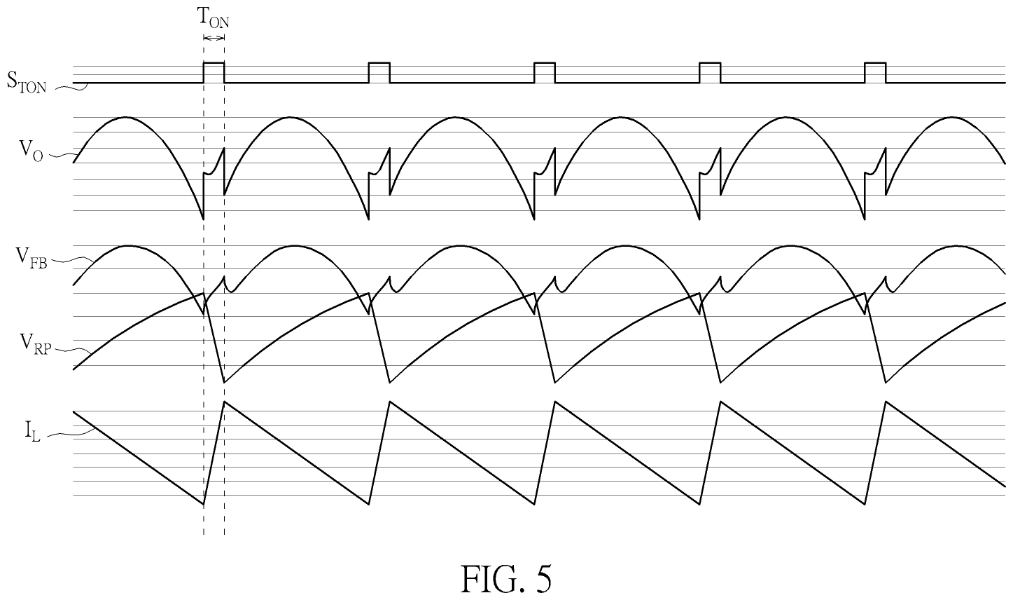

Please further refer to FIG. 4 and FIG. 5. FIG. 5 is a waveform diagram of the operations of power conversion circuit 4 shown in FIG. 4 according to an embodiment of the disclosure. During the on-time duration T_{ON} of the on-time control signal S_{TON}, the auxiliary switch SW is turned on, and the first current I_{DCHG} flows through the compensation capacitor C_{RP}, the auxiliary switch SW and the current source 426 form a discharge path for discharging the compensation capacitor C_{RP}, such that the compensation capacitor C_{RP} is discharged through the discharge path from the compensation capacitor CR to the current source 426, resulting in a decrease of the adjusted reference voltage V_{RP}. Moreover, when the auxiliary switch SW is in the off state, the compensation capacitor C_{RP} is charged and the adjusted reference voltage V_{RP} increases. As shown in FIG. 5, the adjusted reference voltage V_{RP} increases gradually during system operation, and the adjusted reference voltage V_{RP} decreases based on that the compensation capacitor C_{RP} is discharged via the current source 426 during the on-time duration T_{ON}. In other words, the waveform of the adjusted reference voltage V_{RP} is equal to the waveform of the inversion of the inductor current I_{L}. The adjusted reference voltage V_{RP} generated by the embodiments of the present disclosure may be the difference between the first reference voltage V_{REF} with a fixed value used in conventional method and the inductor current I_{L}. Therefore, the phase difference between the first output voltage V_{O} of the power conversion circuit 4 and the inductor current I_{L} may be reduced, thus reducing the impact of the equivalent series resistor ESR of the output capacitor C_{O} and effectively improving the system stability.

Please further refer to FIG. 4. The offset control circuit 44 includes an error amplifier 442. A first input terminal (e.g., inverting input terminal) of the error amplifier 442 is configured to receive a voltage signal that can reflect the first output voltage V_{O}. For example, as shown in FIG. 4, the first input terminal of the error amplifier 442 is configured to receive the first output voltage V_{O}. A second input terminal (e.g., non-inverting input terminal) of the error amplifier 442 is configured to receive the first reference voltage V_{REF}. An output terminal of the error amplifier 442 is coupled to a control terminal of the operational amplifier circuit 422. The error amplifier 442 is configured to generate an error signal V_{C} according to the first output voltage V_{O} and the first reference voltage V_{REF}, and provide the error signal V_{C} to the control terminal of the operational amplifier circuit 422. The error amplifier 442 may be a high gain amplifier circuit (e.g., with a gain of being greater than 60 decibels (dB)), which can amplify small differences between signals into larger signals. During operations of the power conversion circuit, the error amplifier 442 performs error accumulation and continuously accumulates the difference between the signals at the two input terminals (e.g., first output voltage V_{O} and first reference voltage V_{REF}) to generate an error signal V_{C}. The error signal V_{C} may be positive or negative. The adjusted reference voltage V_{RP} outputted by the operational amplifier circuit 422 may be determined based on the first reference voltage V_{REF} and an offset voltage V_{off} of the operational amplifier circuit 422. The offset voltage V_{off} of the operational amplifier circuit 422 may be adjusted according to the error signal V_{C} generated based on the first output voltage V_{O} and the first reference voltage V_{REF}. The relationship of the offset voltage V_{off} and the error signal V_{c} may be expressed as follows:

$$\frac{{V}_{off}}{{V}_{C}} = K \qquad ( 2 )$$

Where V_{off} represents the offset voltage, V_{C} represents the error signal, and K represents a gain voltage value.

Please further refer to FIG. 4. During operations of the power conversion circuit 4, when the first output voltage V_{O} is lower than the first reference voltage V_{REF}, the level of the error signal V_{C} generated by the error amplifier 442 may gradually increase. As the level of the error signal V_{C} increases, the offset voltage V_{off} of the operational amplifier circuit 422 increases and accordingly the adjusted reference voltage V_{RP} also increases. Under such a situation, the comparator 46 generates the comparison signal TON_SHOT according to the adjusted reference voltage V_{RP} so as to control the on-time control circuit 48 to generate the on-time control signal S_{TON} with a high-level pulse (on-time duration is T_{ON}). The on-time control circuit 48 generates the on-time control signal S_{TON} with high-level pulse to drive the operation of the main switch, such that the first output voltage V_{O} may rise. Finally, through the control of the offset control circuit 44, the first output voltage V_{O} and the first reference voltage V_{REF} may be very close to or equal to each other. That is, the average value of the first output voltage V_{O} may be very close to or equal to the first reference voltage V_{REF}, thus effectively improving the output voltage accuracy.

Please further refer to FIG. 4. A first input terminal (e.g., inverting input terminal) of the comparator 46 is coupled to the output capacitor C_{O} and configured to receive a voltage signal that can reflect the first output voltage V_{O}. For example, as shown in FIG. 4, the first input terminal of the comparator 46 is configured to receive the first output voltage V_{O}. A second input terminal (e.g., non-inverting input terminal) of the comparator 46 is coupled to the reference signal generation circuit 42 and configured to receive the adjusted reference voltage V_{RP}. An output terminal of the comparator 46 is configured to output a comparison signal TON_SHOT. The comparator 46 compares the first output voltage V_{O} with the adjusted reference voltage V_{RP}, and accordingly generates the comparison signal TON_SHOT. The on-time control circuit 48 is coupled to the output terminal of the comparator 46 and configured to generate an on-time control signal S_{TON} to the driving circuit 50 according to the comparison signal TON_SHOT. The driving circuit 50 is coupled to the on-time control circuit 48 and configured to generate a driving control signal to control the operations of the main switch UG according to the on-time control signal S_{TON}. When the comparison signal TON_SHOT is at a rising edge, the control circuit 40 may control the main switch UG to be turned on and the inductor L may absorb electrical energy from the power supply PS and output the electrical energy to the load, such that the input voltage V_{I} may be converted into the first output voltage VO. For example, when the first output voltage V_{O} is lower than the adjusted reference voltage V_{RP}, the comparator 46 generates the comparison signal TON_SHOT to trigger the on-time control circuit 48, and the on-time control circuit 48 generates the on-time control signal S_{TON} with high-level pulse (e.g., on-time duration is T_{ON}) to the driving circuit 50 according to the comparison signal TON_SHOT. As such, the control circuit 40 generates the driving control signal according to the on-time control signal S_{TON} so as to control the main switch UG to be turned on. That is, when the first output voltage V_{O} is lower than the adjusted reference voltage V_{RP}, the control circuit 40 may control the main switch UG to be turned on such that the power supply PS transfers energy to the output capacitor C_{O} and the first output voltage V_{O} increases. In addition, the on-time control signal STON generated by the on-time control circuit 48 may control the operations of the main switch UG to adjust the first output voltage V_{O}. The auxiliary switch SW of the compensation branch circuit 424 is also controlled by the on-time control signal S_{TON} to periodically discharge the compensation capacitor C_{RP} to adjust the level of the adjusted reference voltage V_{RP}.

In other words, the embodiments of the present disclosure may utilize the reference signal generation circuit 42 to generate the adjusted reference voltage V_{RP} to reduce the phase difference between the first output voltage V_{O} of the power conversion circuit 4 and the inductor current I_{L}, thus improving system stability. Moreover, through the control of the offset control circuit 44, the average value of the first output voltage V_{O} may be very close to or equal to the first reference voltage V_{REF}, thus effectively improving the output voltage accuracy.

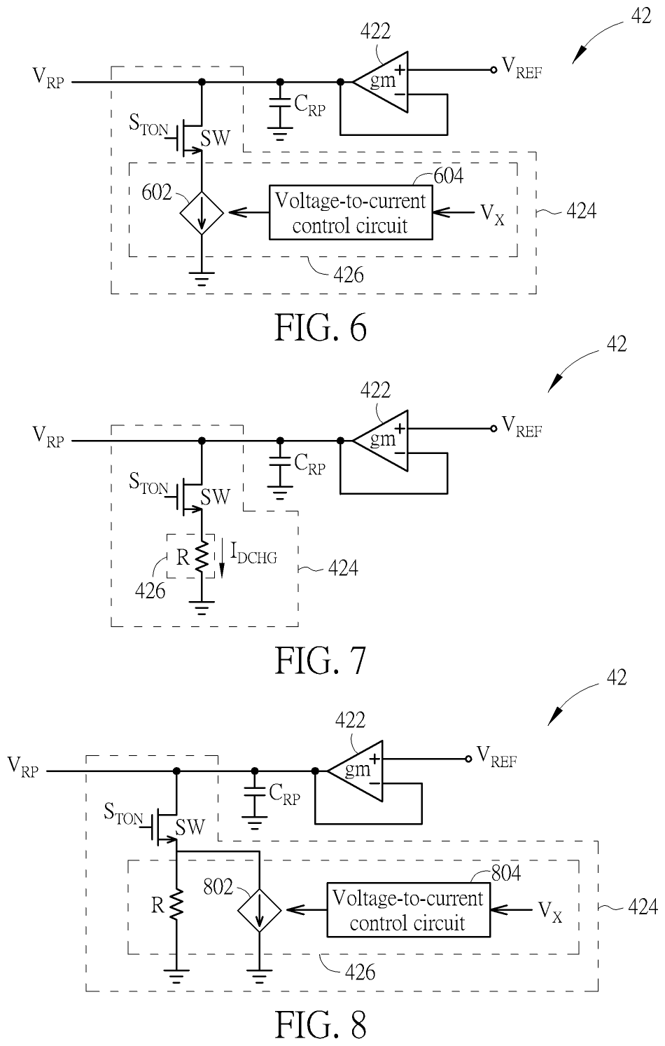

In an embodiment, please refer to FIG. 6. FIG. 6 is a schematic diagram illustrating an alternative embodiment of the current source 426 shown in FIG. 4 according to an embodiment of the present disclosure. The current source 426 of the reference signal generation circuit 42 is configured to generate a first current I_{DCHG}, and when auxiliary switch is turned on, the first current I_{DCHG} discharges the compensation capacitor C_{RP} so as to adjust the adjusted reference voltage V_{RP}. As shown in FIG. 6, the current source 426 includes a controlled current source 602 and a voltage-to-current control circuit 604. The controlled current source 602 and the auxiliary switch SW are connected in series with each other. The voltage-to-current control circuit 604 is coupled to the controlled current source 602. The voltage-to-current control circuit 604 is configured to control the controlled current source 602 to generate the first current I_{DCHG} according to a voltage Vx. The first current I_{DCHG} is controlled by the voltage Vx. If the transconductance gain of the voltage-to-current control circuit 604 is gm_DCHG and the on-time duration of the on-time control signal S_{TON} is T_{ON}. The first current I_{DCHG} is equal to the product of the voltage Vx and the transconductance gain gm_DCHG of the voltage-to-current control circuit 604 (i.e. I_{DCHG}=Vx*gm_DCHG). Therefore, the magnitude of the amplitude A of the adjusted reference voltage V_{RP} may be expressed as follows:

$$A = {T}_{ON} * ( \frac{V x * gm\_DCHG}{{C}_{RP}} ) \qquad ( 3 )$$

According to equation (3), the embodiments of the present disclosure may set the voltage Vx according to system requirements so as to adjust the amplitude of the adjusted reference voltage V_{RP}. For example, the voltage Vx may be set to the input voltage V_{I}, the first output voltage V_{O}, the first reference voltage V_{REF} or any other voltage value according to system requirements, to adjust the amplitude of the adjusted reference voltage V_{RP}. For example, the voltage Vx may be set according to requirements of the duty cycle of the power conversion circuit, to adjust the amplitude of the adjusted reference voltage V_{RP}.

In an embodiment, please refer to FIG. 7. FIG. 7 is a schematic diagram illustrating an alternative embodiment of the current source 426 shown in FIG. 4 according to an embodiment of the present disclosure. As shown in FIG. 7, the current source 426 includes a resistor R. When the auxiliary switch SW is turned on, the first current I_{DCHG} flows through the compensation capacitor C_{RP}, the auxiliary switch SW and the resistor R form a discharge path for discharging the compensation capacitor C_{RP}, such that the level of the adjusted reference voltage V_{RP} may be adjusted. In an embodiment, please refer to FIG. 8. FIG. 8 is a schematic diagram illustrating another embodiment of the current source 426 shown in FIG. 4 according to an embodiment of the present disclosure. As shown in FIG. 8, the current source 426 includes a resistor R, a controlled current source 802 and a voltage-to-current control circuit 804. The resistor R and the auxiliary switch SW are connected in series with each other. The controlled current source 802 is connected in parallel to the resistor R. The voltage-to-current control circuit 804 is coupled to the controlled current source 802. The voltage-to-current control circuit 804 is configured to control the controlled current source 802 to generate a second current according to a voltage Vx, such that the current source 426 may output the first current I_{DCHG}. Moreover, when the auxiliary switch SW is turned on, the current source 426 outputs the first current I_{DCHG} and the first current I_{DCHG} discharges the compensation capacitor C_{RP}, so as to adjust the level of the adjusted reference voltage V_{RP}.

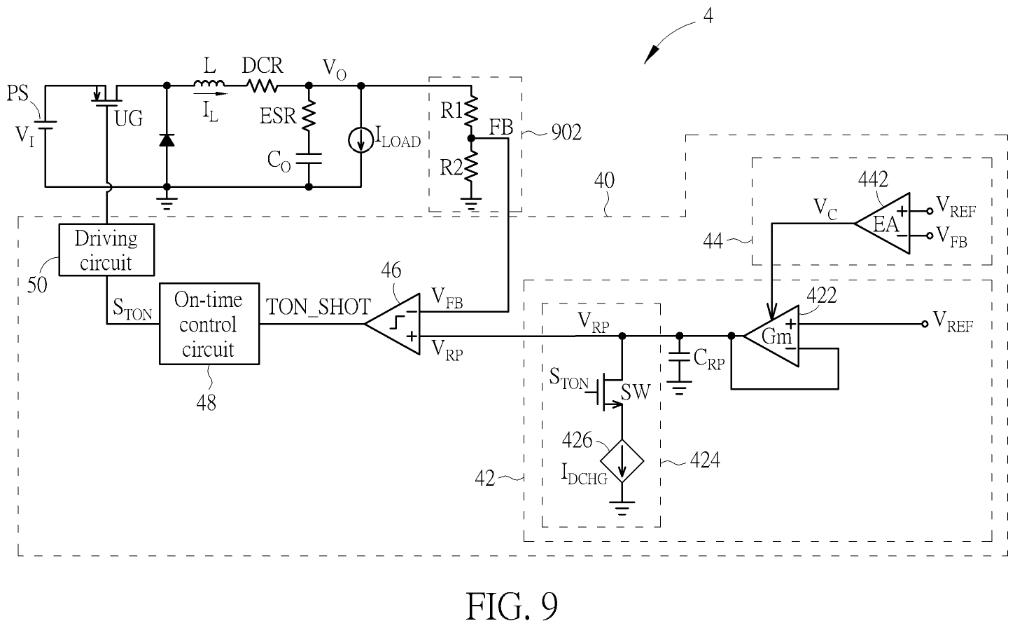

Since the first input terminal of the comparator 46 and the first input terminals of the error amplifier 442 are configured to receive the voltage signal that can reflect the first output voltage V_{O}, the first input terminal of the comparator 46 and the first input terminal of the error amplifiers 442 may receive any signal associated with the first output voltage V_{O} to perform related operations. For example, please refer to FIG. 9, which is a schematic diagram of the power conversion circuit 4 according to an alternative embodiment of the present disclosure. As shown in FIG. 9, the power conversion circuit 4 further includes a voltage divider circuit 902. The voltage divider circuit 902 is configured to divide the first output voltage V_{O} to provide a voltage V_{FB} to the comparator 46. As shown in FIG. 9, the voltage divider circuit 902 is connected in parallel to the output capacitor C_{O}. The voltage divider circuit 902 includes a first resistor R1 and a second resistor R2 connected in series with each other. The resistances of the resistors R1 and R2 may be set in accordance with practical requirements. The first input terminal of the comparator 46 is coupled to a common node FB between the resistor R1 and the resistor R2 to receive a voltage V_{FB} reflecting the first output voltage V_{O}. Similarly, as shown in FIG. 9, the first input terminal of the error amplifier 442 may also be coupled to the common node FB to receive the voltage V_{FB} that can reflect the first output voltage V_{O} for performing related operations.

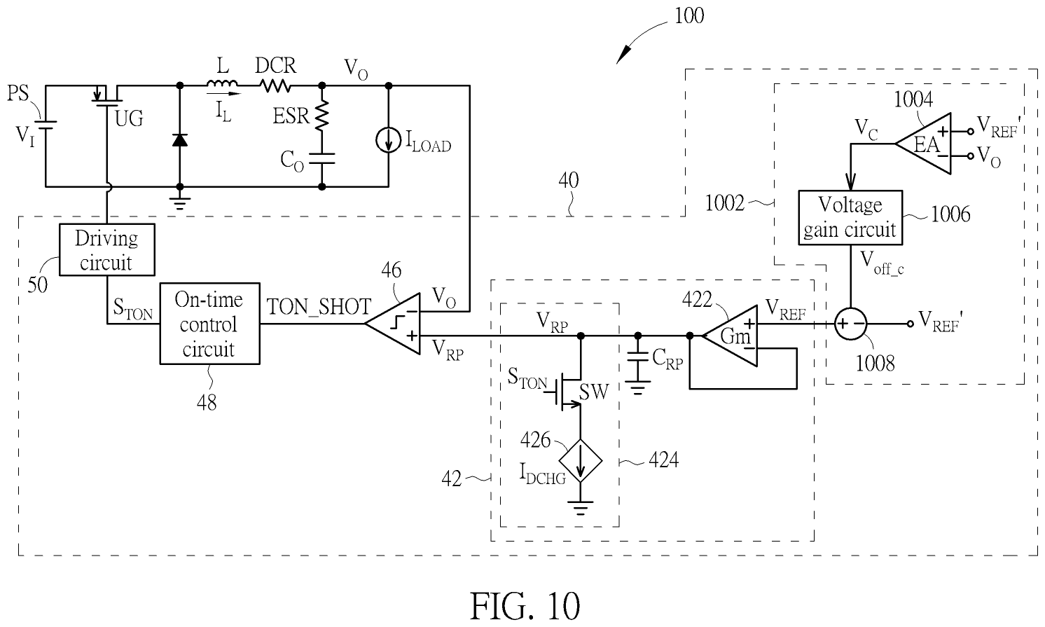

Please refer to FIG. 10, which is a schematic diagram of a power conversion circuit 100 according to a second embodiment of the present disclosure. Please note that the units in the power conversion circuit 100 shown in FIG. 10 with the same designations as those in the power conversion circuit 4 shown in FIG. 4 have similar operations and functions. The interconnections of the units can be referred from FIG. 10 and further description thereof is omitted for brevity. Compared with the power conversion circuit 4 shown in FIG. 4, the control circuit 40 further includes an offset control circuit 1002. The offset control circuit 1002 includes an error amplifier 1004, a voltage gain circuit 1006 and an adder circuit 1008. The error amplifier 1004 may be a high gain amplifier circuit. A first input terminal (e.g., inverting input terminal) of the error amplifier 1004 is configured to receive a voltage signal that can reflect the first output voltage V_{O}. For example, as shown in FIG. 10, the first input terminal of the error amplifier 1004 is configured to receive the first output voltage V_{O}. A second input terminal (e.g., non-inverting input terminal) of the error amplifier 1004 is configured to receive the second reference voltage V_{REF}′. An output terminal of the error amplifier 1004 is coupled to the voltage gain circuit 1006. The error amplifier 1004 is configured to generate an error signal V_{C} to the voltage gain circuit 1006 according to the first output voltage V_{O} and the second reference voltage V_{REF}′. The voltage gain circuit 1006 is coupled to the error amplifier 1004 and configured to amplify the error signal V_{C} to generate an offset compensation signal V_{off_c}. The offset compensation signal V_{off_c} may be determined according to the error signal V_{C}. For example, the offset compensation signal V_{off_c} may be the product of the error signal V_{C} and a gain voltage value. The adder circuit 1008 is coupled to the voltage gain circuit 1006 and the non-inverting input terminal of the operational amplifier circuit 422. The adder circuit 1008 is configured to add the offset compensation signal V_{off_c} and the second reference voltage V_{REF}′ to generate the first reference voltage V_{REF} to the non-inverting input terminal of the operational amplifier circuit 422. The reference signal generation circuit 42 may compensate for the first reference voltage V_{REF} to generate the adjusted reference voltage V_{RP}. For example, the operational amplifier circuit 422 of the reference signal generation circuit 42 and the compensation capacitor C_{RP} may form a unity gain buffer for buffering the first reference voltage V_{REF} received by the non-inverting input terminal of the operational amplifier circuit 422 and outputting the adjusted reference voltage V_{RP}. During operations of the power conversion circuit 100, when the first output voltage V_{O} is lower than the second reference voltage V_{REF}′, the level of the error signal V_{C} generated by the error amplifier 1004 may increase. When the error signal V_{C} increases, the offset compensation signal V_{off_c} increases and the adjusted reference voltage V_{RP} also increases accordingly. Therefore, through the control of the comparator 46, the on-time control circuit 48 and the driving circuit 50, the main switch UG may be turned on and the energy may be transferred to the output capacitor C_{O}, such that the first output voltage V_{O} may rise accordingly. As a result, through the control of the offset control circuit 1002, the average of the first output voltage V_{O} may be very close to or equal to the second reference voltage V_{REF}′, thus effectively improving the output voltage accuracy. The second reference voltage V_{REF}′ may be a fixed value and the second reference voltage V_{REF}′ may be set in accordance with practical requirements.

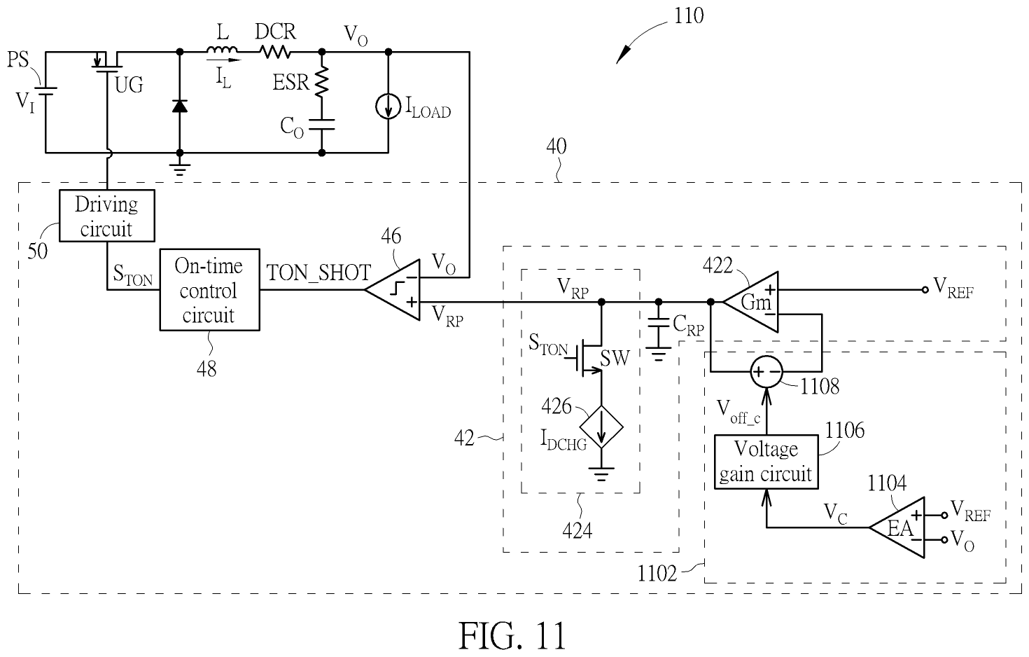

Please refer to FIG. 11, which is a schematic diagram of a power conversion circuit 110 according to a third embodiment of the present disclosure. Please note that the units in the power conversion circuit 110 shown in FIG. 11 with the same designations as those in the power conversion circuit 4 shown in FIG. 4 and the power conversion circuit 100 shown in FIG. 10 have similar operations and functions. The interconnections of the units can be referred from FIG. 11 and further description thereof is omitted for brevity. Compared with the power conversion circuit 4 shown in FIG. 4 and the power conversion circuit 100 shown in FIG. 10, the control circuit 40 further includes an offset control circuit 1102. The offset control circuit 1102 includes an error amplifier 1104, a voltage gain circuit 1106 and an adder circuit 1108. Similar to the error amplifier 1004 and the voltage gain circuit 1006, the error amplifier 1104 may be a high gain amplifier circuit. The error amplifier 1104 is configured to generate an error signal V_{C} to the voltage gain circuit 1106 according to a voltage signal that can reflect the first output voltage V_{O} and the first reference voltage V_{REF}. The voltage gain circuit 1106 is configured to amplify the error signal V_{C} to generate an offset compensation signal V_{off_c}. The offset compensation signal V_{off_c} may be determined according to the error signal V_{C}. For example, the offset compensation signal V_{off_c} may be the product of the error signal V_{C} and a gain voltage value. The adder circuit 1108 is coupled to the voltage gain circuit 1106 and the inverting input terminal of the operational amplifier circuit 422, such that the operational amplifier circuit 422 may generate the adjusted reference voltage V_{RP} according to the first reference voltage V_{REF} and the offset compensation signal V_{off_c}. Therefore, through the control of the offset control circuit 1102, the average of the first output voltage V_{O} may be very close to or equal to the first reference voltage V_{REF}, thus effectively improving the output voltage accuracy.

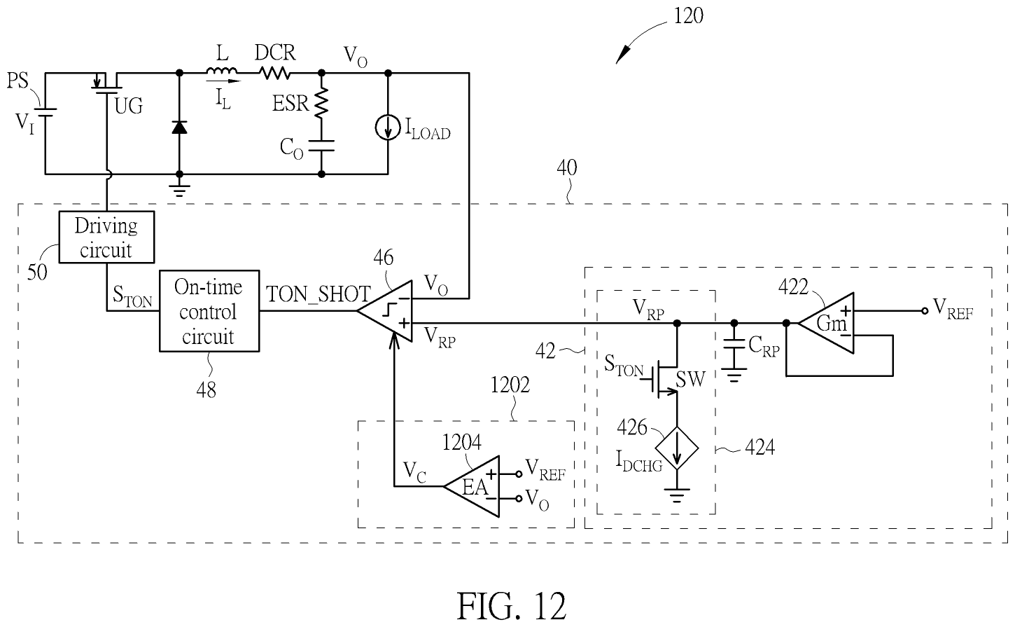

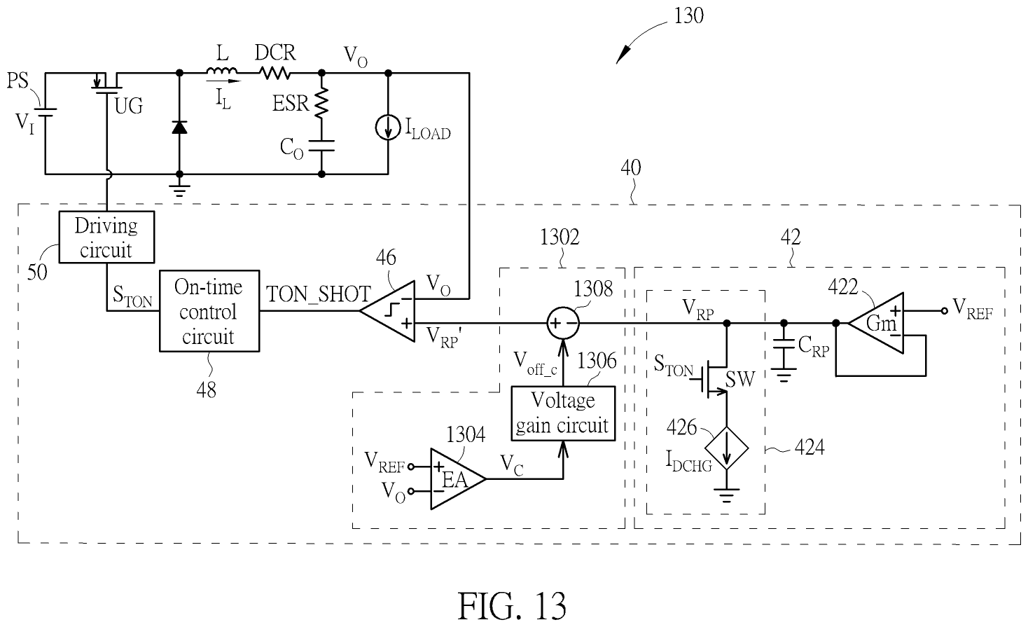

Please refer to FIG. 12, which is a schematic diagram of a power conversion circuit 120 according to a fourth embodiment of the present disclosure. Please note that the units in the power conversion circuit 120 shown in FIG. 12 with the same designations as those in the power conversion circuit 4 shown in FIG. 4 have similar operations and functions. The interconnections of the units can be referred from FIG. 12 and further description thereof is omitted for brevity. Compared with the power conversion circuit 4 shown in FIG. 4, the control circuit 40 further includes an offset control circuit 1202. The offset control circuit 1202 includes an error amplifier 1204. The error amplifier 1204 may be a high gain amplifier circuit. The error amplifier 1204 is configured to generate an error signal V_{C} to an offset voltage control signal terminal of the comparator 46 according to the first output voltage V_{O} and the first reference voltage V_{REF}. The comparator 46 is configured to generate the comparison signal TON_SHOT according to the error signal V_{C}, the adjusted reference voltage V_{RP} and the first output voltage V_{O}. The comparison signal TON_SHOT may be determined according to the adjusted reference voltage V_{RP}, the first output voltage V_{O} and an offset voltage V_{off1} of the comparator 46. The offset voltage V_{off1} of the comparator 46 may be adjusted according to the error signal V_{C} generated based on the first output voltage V_{O} and the first reference voltage V_{REF}. For example, the offset voltage V_{off1} may be the product of the error signal V_{C} and a gain voltage value. When the first output voltage V_{O} is lower than a sum of the adjusted reference voltage V_{RP} and the offset voltage V_{off1}, the comparator 46 outputs a high-level comparison signal TON_SHOT signal to trigger the on-time control circuit 48, such that the on-time control circuit 48 generates the on-time control signal S_{TON} with a high-level pulse (on-time duration is T_{ON}) to the driving circuit 50. Accordingly, the driving circuit 50 controls the main switch UG to be turned on and the energy of the power supply PS may be transferred to the output capacitor C_{O}, such that the first output voltage V_{O} may rise. Therefore, through the control of the offset control circuit 1202, the average of the first output voltage V_{O} may be very close to or equal to the first reference voltage V_{REF}, thus effectively improving the output voltage accuracy.

Please refer to FIG. 13, which is a schematic diagram of a power conversion circuit 130 according to a fifth embodiment of the present disclosure. Please note that the units in the power conversion circuit 130 shown in FIG. 13 with the same designations as those in the power conversion circuit 4 shown in FIG. 4 have similar operations and functions. The interconnections of the units can be referred from FIG. 13 and further description thereof is omitted for brevity. Compared with the power conversion circuit 4 shown in FIG. 4, the control circuit 40 further includes an offset control circuit 1302. The offset control circuit 1302 includes an error amplifier 1304, a voltage gain circuit 1306 and an adder circuit 1308. Similar to the error amplifier 1004 and the voltage gain circuit 1006, the error amplifier 1304 may be a high gain amplifier circuit. The error amplifier 1304 is configured to generate an error signal V_{C} to the voltage gain circuit 1306 according to a voltage signal that can reflect the first output voltage V_{O} and the first reference voltage V_{REF}. The voltage gain circuit 1306 is configured to amplify the error signal V_{C} to generate an offset compensation signal V_{off_c}. The offset compensation signal V_{off_c} may be determined according to the error signal V_{C}. For example, the offset compensation signal V_{off_c} may be the product of the error signal V_{C} and a gain voltage value. The adder circuit 1308 is coupled to the voltage gain circuit 1306 and the output terminal of the operational amplifier circuit 422 and configured to add the offset compensation signal V_{off_c} and the adjusted reference voltage V_{RP} outputted by the operational amplifier circuit 422 to generate a first adjusted reference voltage V_{RP}′ to the second input terminal (e.g., non-inverting input terminal) of the comparator 46. The comparator 46 is configured to compare the first output voltage V_{O} with the first adjusted reference voltage V_{RP}′ to generate the comparison signal TON_SHOT. During operations of the power conversion circuit 130, when the first output voltage V_{O} is lower than the second reference voltage V_{REF}′, the level of the error signal V_{C} generated by the error amplifier 1304 may increase. When the error signal V_{C} increases, the offset compensation signal V_{off_c} increases and the first adjusted reference voltage V_{RP}′ also increases accordingly. Through the control of the comparator 46, the on-time control circuit 48 and the driving circuit 50, the main switch UG may be turned on and the energy may be transferred to the output capacitor C_{O}, such that the first output voltage V_{O} may rise accordingly. Therefore, through the control of the offset control circuit 1302, the average of the first output voltage V_{O} may be very close to or equal to the first reference voltage V_{REF}, thus effectively improving the output voltage accuracy.

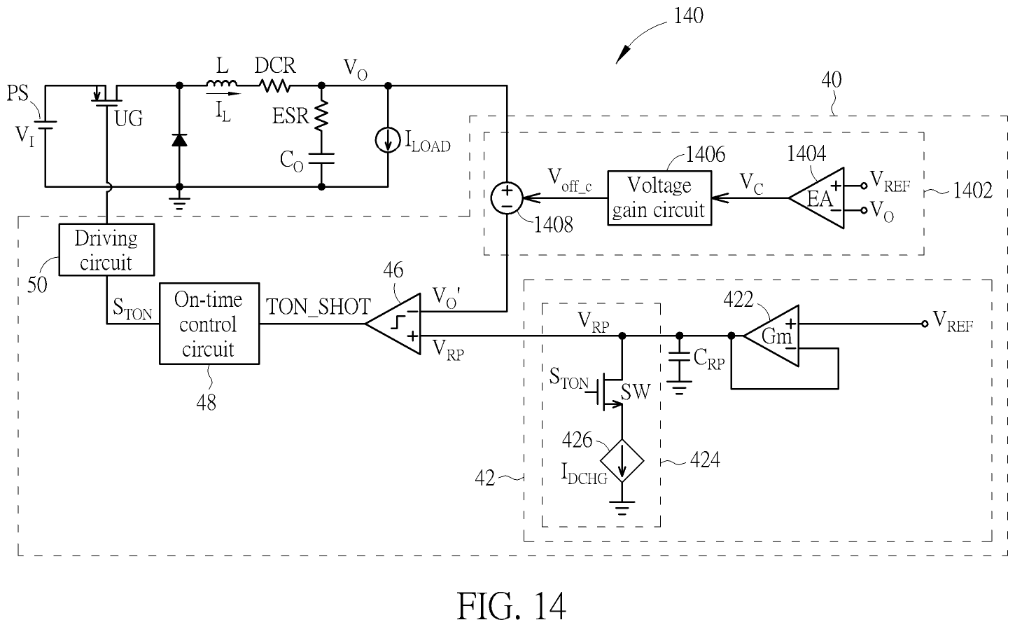

Please refer to FIG. 14, which is a schematic diagram of a power conversion circuit 140 according to a sixth embodiment of the present disclosure. Please note that the units in the power conversion circuit 140 shown in FIG. 14 with the same designations as those in the power conversion circuit 4 shown in FIG. 4 have similar operations and functions. The interconnections of the units can be referred from FIG. 14 and further description thereof is omitted for brevity. Compared with the power conversion circuit 4 shown in FIG. 4, the control circuit 40 further includes an offset control circuit 1402. The offset control circuit 1402 includes an error amplifier 1404, a voltage gain circuit 1406 and an adder circuit 1408. Similar to the error amplifier 1004 and the voltage gain circuit 1006, the error amplifier 1404 may be a high gain amplifier circuit. The error amplifier 1404 is configured to generate an error signal V_{C} to the voltage gain circuit 1406 according to the first output voltage V_{O} and the first reference voltage V_{REF}. The voltage gain circuit 1406 is configured to amplify the error signal V_{C} to generate an offset compensation signal V_{off_c}. The adder circuit 1408 is coupled to the output capacitor C_{O}, the voltage gain circuit 1406 and the first input terminal (e.g., inverting input terminal) of the comparator 46. The adder circuit 1408 is configured to add the offset compensation signal V_{off_c} and the first output voltage V_{O} to generate a second output voltage V_{O}′ to the first input terminal of the comparator 46. The comparator 46 is configured to compare the second output voltage V_{O}′ with the adjusted reference voltage V_{RP} to generate the comparison signal TON_SHOT. During operations of the power conversion circuit 140, when the first output voltage V_{O} is lower than the first reference voltage V_{REF}, the level of the error signal V_{C} generated by the error amplifier 1404 may increase. When the error signal V_{C} increases, the offset compensation signal V_{off_c} increases and the second output voltage V_{O}′ also increases accordingly. Through the control of the comparator 46, the on-time control circuit 48 and the driving circuit 50, the main switch UG may be turned on and the energy may be transferred to the output capacitor C_{O}, such that the first output voltage V_{O} increases accordingly. Therefore, through the control of the offset control circuit 1402, the average of the first output voltage V_{O} may be very close to or equal to the first reference voltage V_{REF}, thus effectively improving the output voltage accuracy.

On the other hand, since the first input terminal of the comparator 46 and the first input terminals of the error amplifiers 1004, 1104, 1204, 1304 and 1404 are utilized to receive the voltage signals capable of reflecting the first output voltage V_{O}. The first input terminal of the comparator 46 and the first input terminals of the error amplifiers 1004, 1104, 1204, 1304 and 1404 may receive any signal associated with the first output voltage V_{O} to perform related operations. Under such a situation, similar to the operations of the power conversion circuit 4 shown in FIG. 9, the first input terminals of the error amplifiers 1004, 1104, 1204, 1304 and 1404 may also be coupled to a voltage divider circuit of the first output voltage V_{O} for receiving a divided voltage of the first output voltage VO to perform related operations.

To sum up, the embodiments of the present disclosure may reduce the phase difference between the output voltage of the power conversion circuit and the inductor current by generating an adjusted reference voltage through the reference signal generation circuit, thereby effectively improving system stability. Moreover, the embodiments of the present disclosure may offer the control functions to make the average value of the output voltage very close to or equal to the reference voltage through the control of the offset control circuit, thus significantly improving the accuracy of the output voltage.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power conversion circuit, comprising a power supply, a main switch, an inductor, an output capacitor and a control circuit electrically connected in sequence, the control circuit comprising:
a reference signal generation circuit, configured to compensate for a first reference voltage and accordingly generate an adjusted reference voltage, comprising:
an operational amplifier circuit, comprising a non-inverting input terminal configured to receive the first reference voltage, an inverting input terminal, and an output terminal coupled to the inverting input terminal of the operational amplifier circuit and configured to generate the adjusted reference voltage;
a compensation capacitor, coupled between the output terminal of the operational amplifier circuit and a ground terminal; and
a compensation branch circuit, coupled between the output terminal of the operational amplifier circuit and the ground terminal and comprising an auxiliary switch and a current source connected in series;
a comparator, comprising a first input terminal coupled to the output capacitor and configured to receive a signal associated with a first output voltage of the power conversion circuit, a second input terminal coupled to the reference signal generation circuit and configured to receive a signal associated with the adjusted reference voltage, and an output terminal configured to output a comparison signal;
an on-time control circuit, coupled to the output terminal of the comparator and configured to generate an on-time control signal according to the comparison signal; and
a driving circuit, coupled to the on-time control circuit and configured to generate a driving control signal according to the on-time control signal, so as to control operations of the main switch of the power conversion circuit.

2. The power conversion circuit of claim 1, wherein when the comparison signal is at a rising edge, the control circuit is configured to control the main switch to be turned on.

3. The power conversion circuit of claim 1, wherein the auxiliary switch is controlled by the on-time control signal and the current source is configured to generate a first current.

4. The power conversion circuit of claim 3, wherein the compensation capacitor is discharged by the first current when the auxiliary switch is turned on.

5. The power conversion circuit of claim 1, wherein the power conversion circuit further comprises:
a voltage divider circuit, connected in parallel to the output capacitor, comprising a first resistor and a second resistor connected in series, and the first input terminal of the comparator is coupled to a common node between the first resistor and the second resistor.

6. The power conversion circuit of claim 1, wherein the operational amplifier circuit is an operational transconductance amplifier.

7. The power conversion circuit of claim 1, wherein the current source of the compensation branch circuit is a constant current source.

8. The power conversion circuit of claim 1, wherein the current source of the compensation branch circuit comprises:
a controlled current source, connected in series with the auxiliary switch; and
a voltage-to-current control circuit, coupled to the controlled current source and configured to control the controlled current source to output the first current according to a first voltage.

9. The power conversion circuit of claim 1, wherein the current source of the compensation branch circuit comprises:
a third resistor, connected in series with the auxiliary switch.

10. The power conversion circuit of claim 1, wherein the current source of the compensation branch circuit comprises:
a third resistor, connected in series with the auxiliary switch;
a controlled current source, connected in parallel to the third resistor; and
a voltage-to-current control circuit, coupled to the controlled current source and configured to control the controlled current source to output a second current according to a first voltage, such that the current source outputs the first current.

11. The power conversion circuit of claim 1, wherein the control circuit further comprises an offset control circuit and the offset control circuit comprises:
an error amplifier, coupled to a control signal terminal of the operational amplifier circuit and configured to generate an error signal to the control signal terminal of the operational amplifier circuit according to the first output voltage and the first reference voltage;
wherein the operational amplifier circuit is configured to generate the adjusted reference voltage according to the first reference voltage and the error signal, the adjusted reference voltage is determined according to the first reference voltage and an offset voltage of the operational amplifier circuit, and the offset voltage is adjusted according to the error signal generated based on the first output voltage and the first reference voltage.

12. The power conversion circuit of claim 1, wherein the control circuit further comprises an offset control circuit and the offset control circuit comprises:
an error amplifier, configured to generate an error signal according to the first output voltage and a second reference voltage;
a voltage gain circuit, coupled to the error amplifier and configured to amplify the error signal to generate an offset compensation signal; and
an adder circuit, coupled to the voltage gain circuit and the non-inverting input terminal of the operational amplifier circuit, and configured to add the offset compensation signal and the second reference voltage to generate the first reference voltage to the non-inverting input terminal of the operational amplifier circuit.

13. The power conversion circuit of claim 1, wherein the control circuit further comprises an offset control circuit and the offset control circuit comprises:
an error amplifier, configured to generate an error signal according to the first output voltage and the first reference voltage;
a voltage gain circuit, coupled to the error amplifier and configured to amplify the error signal to generate an offset compensation signal; and
an adder circuit, coupled to the voltage gain circuit, the inverting input terminal of the operational amplifier circuit and the output terminal of the operational amplifier circuit;
wherein the operational amplifier is configured to generate the adjusted reference voltage according to the first reference voltage and the offset compensation signal.

14. The power conversion circuit of claim 1, wherein the control circuit further comprises an offset control circuit and the offset control circuit comprises:
an error amplifier, coupled to an offset voltage control signal terminal of the comparator, and configured to generate an error signal to the offset voltage control signal terminal of the comparator according to the first output voltage and the first reference voltage;
wherein the comparator is configured to generate the comparison signal according to the error signal, the adjusted reference voltage and the first output voltage, the comparison signal is determined according to the adjusted reference voltage, the first output voltage and an offset voltage of the comparator, and the offset voltage is adjusted according to the error signal generated based on the first output voltage and the first reference voltage.

15. The power conversion circuit of claim 1, wherein the control circuit further comprises an offset control circuit and the offset control circuit comprises:
an error amplifier, configured to generate an error signal according to the first output voltage of the output capacitor and the first reference voltage;
a voltage gain circuit, coupled to the error amplifier and configured to amplify the error signal to generate an offset compensation signal; and
an adder circuit, coupled to the voltage gain circuit and the output terminal of the operational amplifier, and configured to add the offset compensation signal and the adjusted reference voltage of the reference signal generation circuit to generate a first adjusted reference voltage to the second input terminal of the comparator.

16. The power conversion circuit of claim 1, wherein the control circuit further comprises an offset control circuit and the offset control circuit comprises:
an error amplifier, configured to generate an error signal according to the first output voltage of the output capacitor and the first reference voltage;
a voltage gain circuit, coupled to the error amplifier and configured to amplify the error signal to generate an offset compensation signal; and
an adder circuit, coupled to the voltage gain circuit and configured to add the offset compensation signal and the first output voltage of the power conversion circuit to generate a second output voltage to the first input terminal of the comparator.
